(19) United States
(12) Patent Application Publication
(10) Pub. No.: US 2012/0200804 A1
(43) Pub. Date: Aug. 9, 2012

(54) PROJECTION-TYPE DISPLAY APPARATUS

(75) Inventor: Kazu Kobayashi, Kai-shi (JP)

(73) Assignee: Seiko Epson Corporation, Tokyo (JP)

(21) Appl. No.: 13/341,710

(22) Filed: Dec. 30, 2011

(30) Foreign Application Priority Data
Feb. 3, 2011 (JP) 2011-021879

(51) Int. Cl. G02F 1/1335

(52) U.S. Cl. 349/62

(57) ABSTRACT

A projection-type display apparatus includes: a light source that emits light; a plurality of vertical-alignment-mode reflective liquid crystal light valves that respectively modulate the light; phase difference compensating plates which are provided for the respective liquid crystal light valves and in which columnar structures made of an inorganic material are inclined toward substantially one direction of in-plane azimuthal directions of each liquid crystal light valve; a color synthesis optical system that synthesizes the light which are modulated by the plurality of liquid crystal light valves; and a projection optical system that projects the light which are synthesized by the color synthesis optical system. A size of the phase difference compensating plate in the substantially one direction of in-plane azimuthal directions of the columnar structures is larger than a size of a display region of each liquid crystal light valve in a direction corresponding to the substantially one direction.

### BACKGROUND

1. Technical Field

The present invention relates to a projection-type display apparatus.

2. Related Art

Recently, a projector which has a vertical-alignment (which may be hereinafter abbreviated as VA) mode liquid crystal light valve so as to be excellent in contrast when viewed from the front side has been proposed. In the VA-mode liquid crystal light valve, a liquid crystal layer having negative dielectric constant anisotropy is sandwiched between a pair of substrates, and liquid crystal molecules are substantially vertically aligned in a state where a voltage is not applied. However, even by using such a VA-mode liquid crystal light valve, the contrast is lowered when observation is obliquely performed, and thus the display quality is lowered.

Hitherto, by using a phase difference compensating element of which the optical axis is along the thickness direction, that is, a so-called C plate (a negative uniaxial compensating element of which the refractive index is smallest in the thickness direction), the phase difference of light obliquely passing through the liquid crystal layer is compensated. At this time, by tilting the C plate such that the optical axis of the C plate is parallel with the pre-tilt direction of the liquid crystal molecules, the front phase difference of the liquid crystal is compensated by the C plate.

However, when positional deviation of the tilt fixture (deviation of the tilt angle) or deviation of the azimuthal angle of the liquid crystal alignment occurs, the tilting of the C plate is insufficient for the phase difference compensation. Further, when variation occurs in the cell thickness of the liquid crystal panel, it is necessary to adjust the front phase difference of the liquid crystal panel, which is caused by variation in the cell thickness, to the tilt angle of the C plate. In this case, the effective retardation of the C plate is out of the optimum condition thereof, and thus it is difficult to sufficiently compensate the phase difference. Furthermore, as the pre-tilt angle of the liquid crystal molecules increases, the tilt angle of the C plate increases. At this time, the reflectance difference between the P-polarized light and the S-polarized light with respect to the incident polarized light occurs, the axis of the incident polarized light is deviated, and thus the contrast is lowered.

For this reason, there has been proposed a projector using such a C plate and a C+O compensating plate in which the phase difference compensating element with the biaxial refractive index anisotropy that is a so-called O plate is combined (refer to for example JP-A-2009-145862).

In the projector, the phase difference compensating plate formed of the liquid crystal light valve and the C+O compensating plate according to one aspect is mounted in a state where the phase difference compensating plate is disposed in the inside thereof, and a triangular prism of which the internal space serves as an optical path is disposed for each color ray. In addition, regarding the C+O compensating plate, the C plate is formed by vertically vapor-depositing the vapor-deposited film, of which the optical axis is along the thickness direction, on one principal surface of the substrate, and the O plate is formed by obliquely vapor-depositing the vapor-deposited film on the other principal surface of the substrate so as to remove the characteristics of the light caused by the pre-tilt of the liquid crystal molecules. By arranging the plates in parallel with each other, an increase in contrast and space saving are achieved.

However, in the above-mentioned projector, by using the C+O compensating plate, it is not necessary to tilt the compensating plate, and although it is possible to save space, there is a new problem caused by using the C+O compensating plate.

That is, there is a problem in that the phase difference of the C+O compensating plate is changed by change in humidity because of the structure of the O plate belonging thereto.

The change in phase difference is caused by absorption and desorption of moisture generated from the 0 plate. In particular, moisture tends to be absorbed onto and desorbed from the end face of the O plate. Accordingly, the moisture permeates from the end portion of the O plate into the gap between the obliquely vapor-deposited film and the O plate, and thus the phase difference at the end portion of the obliquely vapor-deposited film is changed. As a result, in the liquid crystal layer of the liquid crystal light valve, color unevenness and the like is caused by the change in phase difference between the center portion and the end portion of the O plate in the display screen, and thus there are problems such as deterioration in quality of the display apparatus.

### SUMMARY

An advantage of some aspects of the invention is to provide a projection-type display apparatus capable of preventing the phase difference of the phase difference compensating plate from changing by suppressing absorption and desorption of moisture at the end portion of the phase difference compensating plate and thereby capable of preventing quality of the display apparatus from deteriorating by removing color unevenness and the like caused by the change in phase difference between the center portion and the end portion of the display region of the liquid crystal light valve.

According to an aspect of the invention, there is provided a projection-type display apparatus including: a light source that emits a plurality of color rays with different colors; a plurality of vertical-alignment-mode reflective liquid crystal light valves that respectively modulate the plurality of color rays; phase difference compensating plates which are respectively provided for the plurality of liquid crystal light valves and in which a plurality of columnar structures made of an inorganic material is inclined toward substantially one direction of in-plane azimuthal directions of each liquid crystal light valve; a color synthesis optical system that synthesizes the color rays which are modulated by the plurality of liquid crystal light valves; and a projection optical system that projects the rays, which are synthesized by the color synthesis optical system, onto a projection target surface. A size of the phase difference compensating plate in the substantially one direction of in-plane azimuthal directions, in which the plurality of columnar structures are inclined, is secured to be larger than a size of a display region of each liquid crystal light valve in a direction corresponding to the substantially one direction.

In the projection-type display apparatus, the size of the phase difference compensating plate in the substantially one direction of in-plane azimuthal directions, in which the plurality of columnar structures are inclined, is secured to be larger than the size of a display region of each liquid crystal light valve in the direction corresponding to the substantially one direction, whereby it is possible to position the end portions, which tend to be affected by the absorption and desorption of the moisture in the phase difference compensating plate, outside the display region of each liquid crystal light valve. Accordingly, in the display region of the liquid crystal light valve, display is performed by using the light which is transmitted through a region which is less likely to be affected by the absorption and desorption of moisture on the phase difference compensating plate. As a result, it is possible to remove color unevenness and the like caused by the change in phase difference between the center portion and the end portion of the display region of the liquid crystal light valve, and thus it is possible to prevent quality of the display apparatus from deteriorating.

In the projection-type display apparatus according to the aspect of the invention, the end portions of the phase difference compensating plate may be covered by a covering material.

In the projection-type display apparatus, the end portions of the phase difference compensating plate are covered by the covering material, whereby the end portions, which tend to be affected by the absorption and desorption of the moisture, in the phase difference compensating plate are covered by the covering material. Accordingly, it is possible to prevent the moisture from permeating from the end portions into the phase difference compensating plate. As a result, it is possible to prevent color unevenness and the like, which are caused by the change in phase difference between the center portion and the end portion of the display region of the liquid crystal light valve, from occurring, and thus it is possible to prevent quality of the display apparatus from deteriorating.

In the projection-type display apparatus according to the aspect of the invention, the liquid crystal light valve and the phase difference compensating plate may be supported by one surface of each of a plurality of casings of which internal spaces serve as optical paths.

In the projection-type display apparatus, the liquid crystal light valve and the phase difference compensating plate are supported by one surface of each of the plurality of casings of which the internal spaces serve as the optical paths, whereby it is possible to miniaturize the structure including the liquid crystal light valves and the phase difference compensating plate.

Further, by forming a sealed structure in the casing, the change in phase difference of the phase difference compensating plate disposed in the casing is eliminated. As a result, it is possible to prevent the contrast thereof from deteriorating.

In the projection-type display apparatus according to the aspect of the invention, a size of the end portion of the phase difference compensating plate on a side, in which the substantially one direction of the in-plane azimuthal directions is within an angular range less than ±45° with respect to a line bisecting one substrate side of mutually adjacent sides of the phase difference compensating plate, may be secured to be larger than a size of the end portion thereof on a side, in which the substantially one direction of the in-plane azimuthal directions is within an angular range greater than ±45° with respect to a line bisecting the other substrate side of the mutually adjacent sides of the phase difference compensating plate, relative to the display region of each liquid crystal light valve.

In the projection-type display apparatus, the size of the end portion of the phase difference compensating plate on the side, in which the substantially one direction of the in-plane azimuthal directions is within the angular range less than ±45° with respect to the line bisecting one substrate side of mutually adjacent sides of the phase difference compensating plate, may be secured to be larger than the size of the end portion thereof on the side, in which the substantially one direction of the in-plane azimuthal directions is within the angular range greater than ±45° with respect to the line bisecting the other substrate side of the mutually adjacent sides of the phase difference compensating plate, relative to the display region of each liquid crystal light valve. Thereby, it is possible to set the size of the side, which tends to be affected by the absorption and desorption of moisture, to a large size in the phase difference compensating plate. Accordingly, in the display region of the liquid crystal light valve, display is performed by using the light which is transmitted through a region, which is less likely to be affected by the absorption and desorption of moisture, in the phase difference compensating plate. As a result, it is possible to remove color unevenness and the like caused by the change in phase difference between the center portion and the end portion of the display region of the liquid crystal light valve, and thus it is possible to prevent quality of the display apparatus from deteriorating.

In the projection-type display apparatus according to the aspect of the invention, the phase difference compensating plate may be formed by combining a C plate with an O plate.

In the projection-type display apparatus, the phase difference compensating plate may be formed by combining the C plate with the 0 plate, whereby it is possible to reduce the size and save space, and thus it is easy to dispose the apparatus.

### BRIEF DESCRIPTION OF THE DRAWINGS

The invention will be described with reference to the accompanying drawings, wherein like numbers reference like elements.

FIG. 1 is a schematic configuration diagram illustrating a projector according to a first embodiment of the invention.

FIG. 2 is a perspective view illustrating a peripheral configuration of a liquid crystal light valve of the projector according to the first embodiment of the invention.

FIG. 3 is a cross-sectional view of a triangular prism unit that supports the liquid crystal light valve of the projector according to the first embodiment of the invention.

FIG. 4A to 4C are cross-sectional views illustrating a schematic configuration of a phase difference compensating plate of the projector according to the first embodiment of the invention.

FIG. 5A and 5B are schematic diagrams illustrating optical anisotropy of a C plate and an O plate of the phase difference compensating plate.

FIG. 6 is a cross-sectional view illustrating a principal section of the triangular prism unit that supports the liquid crystal light valve of the projector according to the first embodiment of the invention.

FIG. 7A and 7B are diagrams illustrating a film structure that has columns of the O plate of the phase difference compensating plate of the projector according to the first embodiment of the invention.

FIG. 8 is a diagram illustrating variation in the phase differences in the in-plane directions in the display region of the liquid crystal display apparatus of the projector according to the first embodiment of the invention.

FIG. 9 is a cross-sectional view illustrating a principal section of a triangular prism unit that supports a liquid crystal light valve of a projector according to a second embodiment of the invention.

### DESCRIPTION OF EXEMPLARY EMBODIMENTS

### First Embodiment

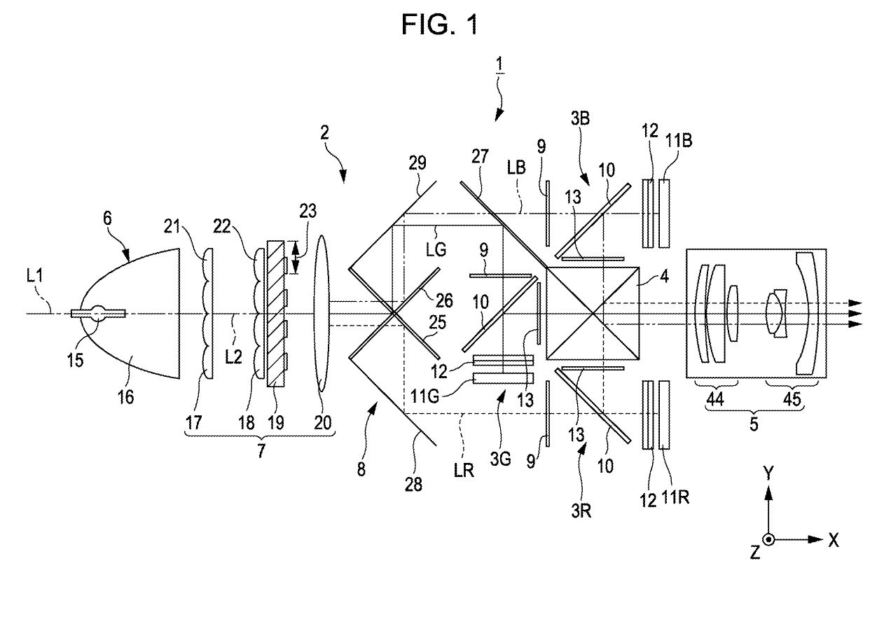

Hereinafter, a first embodiment of the invention will be described with reference to FIGS. 1 to 4.

In the embodiment, a projector having three reflective liquid crystal light valves, that is, a so-called three-plate type liquid crystal projector is exemplified.

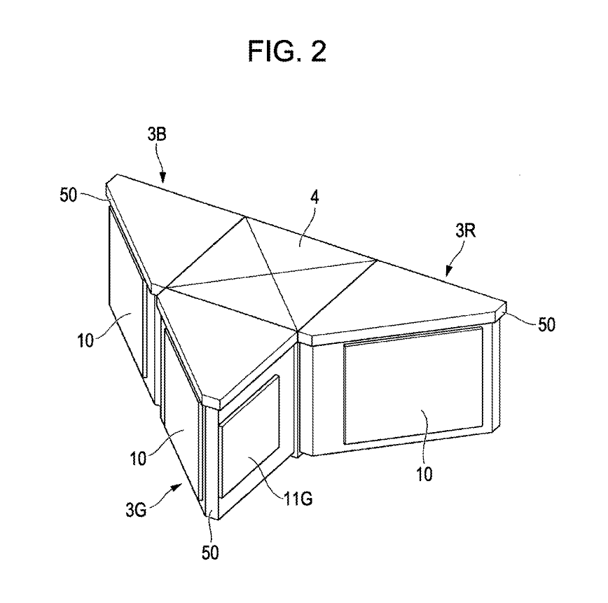

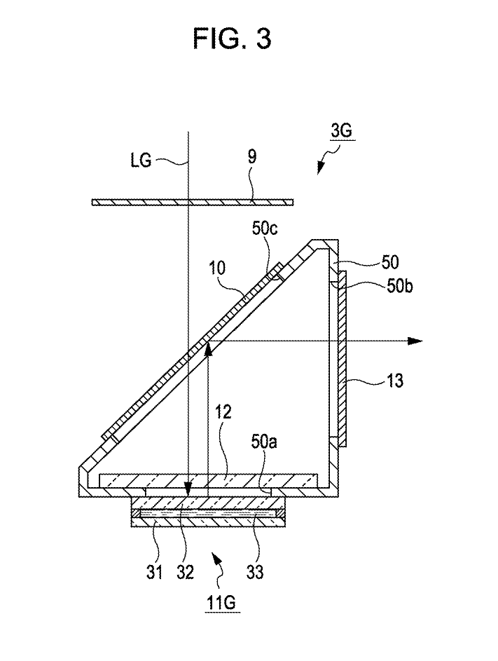

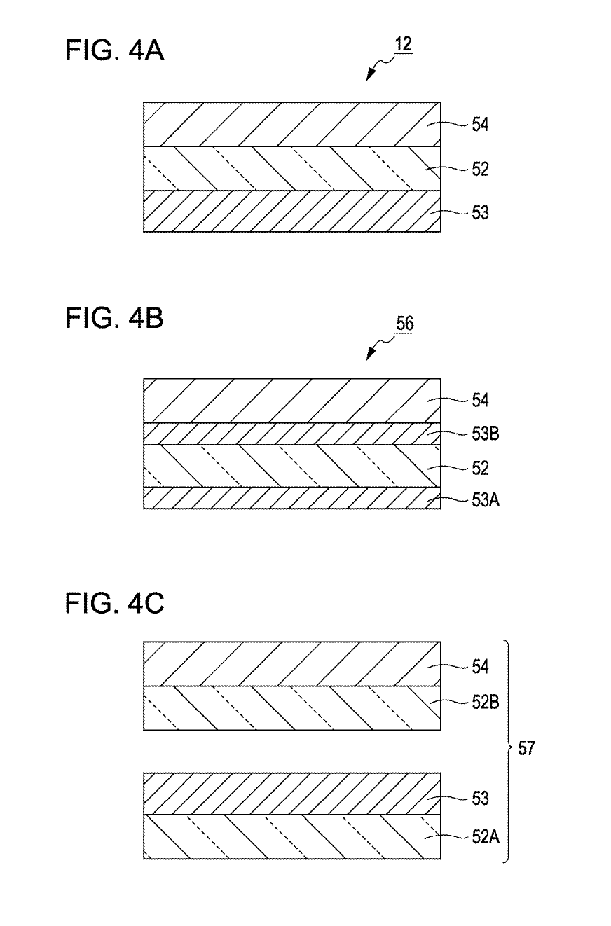

FIG. 1 is a schematic configuration diagram illustrating a projector according to the embodiment. FIG. 2 is a perspective view illustrating a peripheral configuration of a liquid crystal light valve of the projector. FIG. 3 is a cross-sectional view of a triangular prism unit that supports the liquid crystal light valve. FIGS. 4A to 4C are cross-sectional views illustrating schematic configurations of a phase difference compensating plate of the projector.

In addition, in all the following drawings, in order to facilitate understanding of respective components, the scales of the dimensions of the components may be differently illustrated.

The projector 1 according to the embodiment includes, as shown in FIG. 1: an illumination device 2 that emits three-color rays formed of red light (R light), green light (G light), and blue light (B light); three image formation optical systems 3R, 3G, and 3B that form an image by using the respective color rays; a color synthesis element 4 (color synthesis optical system) that synthesizes the three-color rays; and a projection optical system 5 that projects the synthesized rays onto a projection target surface (not shown in the drawing) such as a screen. The illumination device 2 includes a light source 6, an integrator optical system 7, and a color separation optical system 8. The image formation optical system 3R, 3G, or 3B includes an incident-side polarization plate 9, a PBS 10, a reflective liquid crystal light valve 11R, 11G, or 11B, a phase difference compensating plate 12, and an exit-side polarization plate 13.

The operation of the projector 1 is briefly described as follows.

White rays, which are emitted from the light source 6, are incident to the integrator optical system 7. The white rays, which are incident to the integrator optical system 7, are emitted such that the polarization state is adjusted to a prescribed linear polarization state while the illuminance of the rays is uniformized. The white rays, which are emitted from the integrator optical system 7, are separated into the respective colors of R, G, and B by the color separation optical system 8, and the different color rays are respectively incident to the image formation optical systems 3R, 3G, and 3B. The color rays, which are incident to the respective image formation optical systems 3R, 3G, and 3B, are changed into modulated rays which are modulated on the basis of an image signal of an image to be displayed. The three-color modulated rays, which are emitted from the three image formation optical systems 3R, 3G, and 3B, are synthesized through the color synthesis element 4 so as to thereby be multi-color rays, and are incident to the projection optical system 5. The multi-color rays, which are incident to the projection optical system 5, are projected onto the projection target surface such as a screen. In such a manner, a full color image is displayed on the projection target surface.

Hereinafter, the respective components of the projector 1 will be described in detail.

The light source 6 has a light source lamp 15 and a parabolic reflector 16. The light, which is emitted from the light source lamp 15, is reflected by the parabolic reflector 16 in one direction, is thereby changed into substantially parallel rays, and is incident as a source light to the integrator optical system 7. The light source lamp 15 is formed by, for example, a metal halide lamp, a xenon lamp, a high-pressure mercury lamp, a halogen lamp, or the like. Instead of the parabolic reflector 16, the reflector may be formed by an elliptical reflector, a spherical reflector, or the like. In accordance with the shape of the reflector, a collimator lens, which collimates the light emitted from the reflector, may be used.

The integrator optical system 7 has a first lens array 17, a second lens array 18, a polarization conversion element 19, and a superimposing lens 20. The first lens array 17 has a plurality of micro lenses 21 which are arranged on a surface substantially orthogonal to an optical axis L1 of the light source 6. The second lens array 18 has a plurality of micro lenses 22, similarly to the first lens array 17. The respective micro lenses 21 and 22 are arranged in a matrix, and the planar shape of the plane orthogonal to the optical axis L1 is a shape (substantially rectangular shape) similar to that of the target illumination region of the liquid crystal light valves 11R, 11G, and 11B. The target illumination region is defined as a region in which plural pixels in the liquid crystal light valves 11R, 11G, and 11B are arranged in a matrix and which practically contributes to display.

The PBS 10 is a wire-grid PBS, and is constituted by, for example, a glass substrate and a plurality of metal wires formed thereon (not shown in the drawing). All the plurality of metal wires extend in one direction (Z direction), and are thus formed on the glass substrate so as to be separated from each other in substantially parallel. The principal surface of the glass substrate, on which the plurality of metal wires is formed, is formed as a polarized light separation plane. The direction of extending the plurality of metal wires is a reflection axis direction, and the direction of arranging the plurality of metal wires is a transmission axis direction. The polarized light separation plane forms an angle of about 45° with respect to the center axis of the light which is incident on the polarized light separation plane. Among the light which is incident on the polarized light separation plane, S-polarized light, of which the polarization direction coincides with the reflection axis direction, is reflected on the polarized light separation plane, and P-polarized light, of which the polarization direction coincides with the transmission axis direction, is transmitted through the polarized light separation plane. Hereinafter, the P-polarized light through the polarized light separation plane of the PBS 10 is simply referred to as P-polarized light, and the S-polarized light through the polarized light separation plane of the PBS 10 is simply referred to as S-polarized light.

In the phase difference compensating plate 12, a C plate (negative uniaxial C plate) is formed on one surface of the substrate made of quartz glass, and an O plate is formed on the other surface. The phase difference compensating plate 12 is formed as a C+O compensating plate by combining the C plate, of which the surface is perpendicular to the optical axis, with the O plate which has biaxial refractive-index anisotropy. Thereby, it is not necessary to tilt the compensating plate as in the related art, and thus it is possible to save the space thereof, and it is easy to dispose the apparatus.

The polarization conversion element 19 has a plurality of polarization conversion units 23. Although the specific structure thereof is not shown, each polarization conversion unit 23 has a polarization beam splitter film (hereinafter referred to as a PBS film), a 1/2 phase plate, and a reflection mirror. The respective micro lenses 21 of the first lens array 17 correspond one-to-one with the respective micro lenses 22 of the second lens array 18. The respective micro lenses 22 of the second lens array 18 correspond one-to-one with the respective polarization conversion units 23 of the polarization conversion element 19.

The source light, which is incident to the integrator optical system 7, is spatially split and incident to the plurality of micro lenses 21 of the first lens array 17, and is concentrated through the micro lens 21 for each incident ray. The source light, which is concentrated through each micro lens 21, forms an image on the micro lens 22 of the second lens array 18 corresponding to the micro lens 21. That is, a secondary light source image is formed on each of the plurality of micro lenses 22 of the second lens array 18. The light from the secondary light source image formed on the micro lens 22 is incident to the polarization conversion unit 23 corresponding to the micro lens 22.

The light, which is incident to the polarization conversion unit 23, is separated into the P-polarized light and S-polarized light through the PBS film. One separated polarized light (for example, S-polarized light) is reflected by the reflection mirror, and then passes through the 1/2 phase plate, whereby its polarization state is converted, and the light can be adjusted to the other polarized light (for example, P-polarized light). Here, the polarization state of the light passing through the polarization conversion unit 23 is adjusted to the polarization state of the light transmitted through the incident-side polarization plate 9 to be described later. The light, which is emitted from the plurality of polarization conversion units 23, is superimposed upon the target illumination region of the liquid crystal light valves 11R, 11G, and 11B through the superimposing lens 20. The rays spatially separated by the first lens array 17 illuminate substantially the entire area of the target illumination region. Thereby, the illuminance distribution is averaged, and the illuminance on the target illumination region is uniformized.

The color separation optical system 8 has a first dichroic mirror 25, a second dichroic mirror 26, and a third dichroic mirror 27 which have wavelength selection surfaces, and a first reflection mirror 28 and a second reflection mirror 29. The first dichroic mirror 25 has a spectral characteristic that reflects red light LR and transmits green light LG and blue light LB. The second dichroic mirror 26 has a spectral characteristic that transmits the red light LR and reflects the green light LG and the blue light LB. The third dichroic mirror 27 has a spectral characteristic that reflects the green light LG and transmits the blue light LB. The first dichroic mirror 25 and the second dichroic mirror 26 are arranged such that the respective wavelength selection surfaces are substantially orthogonal to each other and the respective wavelength selection surfaces form an angle of about 45° with respect to the optical axis L2 of the integrator optical system 7.

The red light LR, green light LG, and blue light LB, which are included in the source light incident to the color separation optical system 8, are separated in the following manner, and are incident to the image formation optical systems 3R, 3G, and 3B respectively corresponding to the separated color rays. That is, after the red light LR is transmitted through the second dichroic mirror 26 and is reflected by the first dichroic mirror 25, the light is reflected by the first reflection mirror 28, and is incident to the image formation optical system 3R for the red light. After the green light LG is transmitted through the first dichroic mirror 25 and is reflected by the second dichroic mirror 26, the light is reflected by the second reflection mirror 29, is reflected by the third dichroic mirror 27, and is incident to the image formation optical system 3G for the green light. After the blue light LB is transmitted through the first dichroic mirror 25 and is reflected by the second dichroic mirror 26, the light is reflected by the second reflection mirror 29, is transmitted through the third dichroic mirror 27, and is incident to the image formation optical system 3B for blue light. The light, which is modulated by each image formation optical system, is incident to a color synthesis element 4.

The color synthesis element 4 is constituted by a dichroic prism. The dichroic prism has a structure which is formed by attaching four triangular prisms. In the triangular prisms, the attached surfaces are inner surfaces of the dichroic prism. The mirror surface, by which the red light LR is reflected and through which the green light LG is transmitted, and the mirror surface, by which the blue light LB is reflected and through which the green light LG is transmitted, are formed on the inner surface of the dichroic prism so as to be orthogonal to each other. The green light LG, which is incident into the dichroic prism, travels through the mirror surface as it is, and is emitted. The red light LR and the blue light LB incident to the dichroic prism are selectively reflected on or transmitted through the mirror surface, and emitted in a direction the same as the direction of emitting the green light LG. In such a manner, three color rays (images) are superimposed and synthesized, and the synthesized color rays are projected onto the screen 7 in an enlarged manner by the projection optical system 5. The projection optical system 5 has a first lens group 44 and a second lens group 45.

In the case of the embodiment, as shown in FIG. 2, each of the image formation optical system 3R for the red light, the image formation optical system 3G for the green light, and the image formation optical system 3B for the blue light is unitized, and thus has the same configuration. The three unitized image formation optical systems are bonded to three surfaces of the color synthesis element.

Here, as a representative of the image formation optical system, the configuration of the image formation optical system 3G for the green light will be described.

The image formation optical system 3G for the green light includes, as shown in FIG. 3, the incident-side polarization plate 9, the PBS 10, the liquid crystal light valve 11G for the green light, the phase difference compensating plate 12, and the exit-side polarization plate 13. In addition, it is preferable that the incident-side polarization plate 9 and the exit-side polarization plate 13 be formed of a wire-grid polarization plate in consideration of heat resistance.

The liquid crystal light valve 11G for the green light is a reflective liquid crystal light valve, and the liquid crystal mode is the vertical alignment mode. The liquid crystal light valve 11G for the green light has a TFT array substrate 31 and a counter substrate 32, which are disposed to be opposed to each other, and a liquid crystal layer 33 which is sandwiched between two substrates. The liquid crystal layer 33 is formed of a liquid crystal material of which the dielectric constant anisotropy is negative.

The phase difference compensating plate 12 is disposed in the optical path between the PBS 10 and the liquid crystal light valve 11G for the green light.

The phase difference compensating plate 12 is configured as shown in FIG. 4A such that the C plate (negative uniaxial C plate) 53 is formed on one surface of the substrate 52 made of quartz glass and the O plate 54 is formed on the other surface. That is, in the embodiment, the C plate 53 and the O plate 54 are combined as one body. The phase difference compensating plate 12 having such a configuration is disposed in parallel with the liquid crystal light valves 11R, 11G, and 11B such that the C plate 53 is positioned on the side of the liquid crystal light valves 11R, 11G, and 11B, and the O plate 54 is positioned on the side opposite to the liquid crystal light valves.

The C plate 53 is a uniaxial birefringent-index substance formed of a multi-layer film in which high refractive index layers and low refractive index layers are alternately laminated on the substrate 52 through a sputtering method or the like. The C plate 53 compensates the phase difference of the rays of which the optical axes are perpendicular to the surface thereof and which are obliquely emitted from the liquid crystal light valves 11R, 11G, and 11B. The high refractive index layer is made from TiO₂ or ZrO₂ which is a dielectric substance with a relatively high refractive index, and the low refractive index layer is made from SiO₂ or MgF₂ which is a dielectric substance with a low refractive index. In the C plate 53 having such a configuration, in order to prevent the rays transmitted through the C plate 53 from interfering with each other by reflecting between the respective layers, it is preferable that the thickness of each refractive index layer be thin.

On the other hand, the O plate 54 is formed by obliquely vapor-depositing an inorganic material such as Ta₂O₅ on the other surface of the substrate 52 made of quartz glass. When viewed microscopically, the O plate 54 has a film structure that has columns (columnar structures) in which inorganic material grows along a tilt direction. The inorganic film having such a structure causes a phase difference due to the microscopic structure.

In the phase difference compensating plate 12, the C plate 53, of which the surface is perpendicular to the optical axis, and the O plate 54, which has biaxial refractive index anisotropy, are combined as one body. Therefore, it is not necessary to tilt the compensating plate as in the related art, and thus it is possible to save the space thereof, and it is easy to dispose the apparatus.

The phase difference compensating plate 12 in which the C plate (negative uniaxial C plate) 53A is formed on one surface of the substrate 52 and the C plate (negative uniaxial C plate) 53B and the O plate 54 are laminated on the other surface in this order as shown in FIG. 4B, may also be used. In this case, the C plate 53A and the C plate 53B are respectively formed on the substrate 52 such that the optical characteristics of the combination of the C plate (negative uniaxial C plate) 53A and the C plate (negative uniaxial C plate) 53B are the same as those of the C plate 53 shown in FIG. 4A. Thereby, the C plate 53A and the C plate 53B are regarded as a single C plate.

Further, the phase difference compensating plate in which, in place of the C plate and the O plate in FIG. 4B, the C plate and the O plate are laminated on one surface of the substrate 52 in this order and the O plate is formed on the other surface, may also be used. In this case, the optical characteristics of the combination of two O plates with the substrate 52 interposed therebetween are the same as those of the O plate 54 shown in FIG. 4A.

Furthermore, instead of the phase difference compensating plate in which the C plate 53 and the O plate 54 are formed on the single substrate 52 and are combined as one body, the phase difference compensating plate in which, as shown in FIG. 4C, the C plate 53 is formed on the substrate 52A and the O plate 54 is formed on the separate substrate 52B, may also be used. That is, the combination thereof may also be used as one phase difference compensating plate 57.

Here, the optical anisotropy of the phase difference compensating plate 12 will be described.

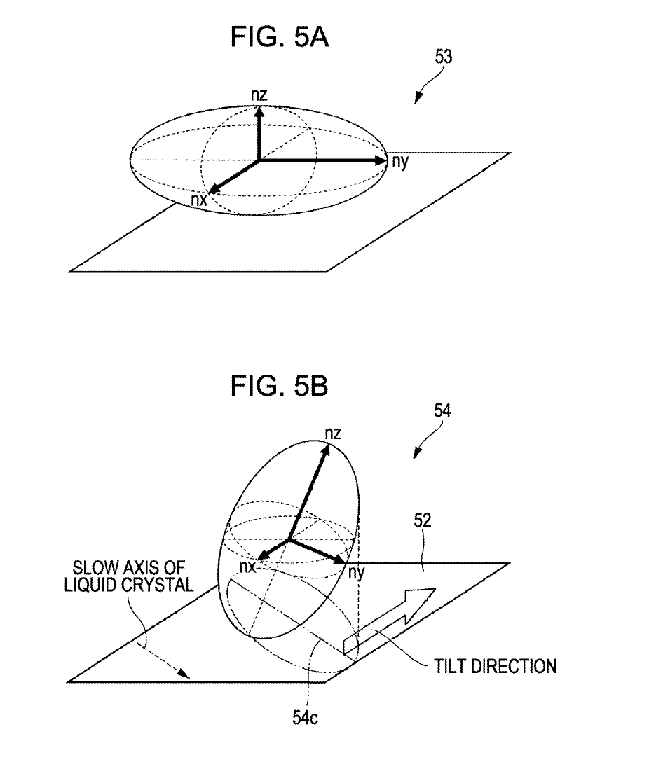

The C plate 53 of the phase difference compensating plate 12 is unable to compensate the phase difference since the relationship of the refractive indices of the C plate in the respective directions is nx=ny>nz and the light incident to the optical axis of the C plate in parallel is isotropic as shown in the refractive index ellipsoidal body of FIG. 5A. That is, it is difficult to compensate the phase difference of the rays which are vertically incident from the liquid crystal panel to the C plate 53. On the other hand, the C plate 53 optically compensates the phase difference of the rays with the tilt components, that is, the tilt components of the VA-mode liquid crystal, among the rays which are emitted from the liquid crystal panel. In addition, it is not necessary for the C plate 53 to completely satisfy nx=ny, a small phase difference is satisfactory, and specifically the front phase difference value being in the range from about 0 nm to 3 nm is satisfactory.

The phase difference Rth in the thickness direction of such a type of C plate 53 is preferably equal to or greater than 100 nm and equal to or less than 300 nm, and is more preferably equal to 180 nm. Here, the phase difference Rth in the thickness direction is defined as the following expression.

Rth={(nx+ny)/2−nz}×d

Here, nx and ny represent the principal refractive indices of the C plate 53 shown in FIG. 5A in the surface direction, and nz represents the principal refractive index thereof in the same thickness direction. Further, d represents the thickness of the C plate.

On the other hand, the O plate 54 is a biaxial phase difference compensating plate configured such that the relationship of the refractive indices in the respective directions is nx<ny<nz (or, is nz<ny<nx although not shown in the drawing) as shown in the refractive index ellipsoidal body of FIG. 5B. The O plate 54 has a slow axis 54c due to the inorganic film in which the above-mentioned columns are formed. The slow axis 54c of the O plate 54 coincides with the long axis of the elliptical shape which is projected onto the substrate 52 (substrate surface) as the refractive index ellipsoidal body shown in FIG. 5B is viewed from the normal line direction of the substrate 52.

In the image formation optical system 3G for the green light, the incident-side polarization plate 9 is excluded from the components, and the PBS 10, the liquid crystal light valve 11G for the green light, the phase difference compensating plate 12, and the exit-side polarization plate 13 are fixed onto a casing 50 which has a substantially triangular prism shape. The casing 50 is formed of a material with high thermal conductivity such as aluminum.

Opening portions 50a to 50c transmitting light are respectively provided on the three side surfaces of the casing 50. Among the three side surfaces of the casing 50, the two surfaces, which are in contact with each other at a right angle, are set as a first side surface and a second side surface, and the surface, which is in contact with the first and second side surfaces at an angle of 45°, is set as a third side surface. On the outer side of the first side surface, the liquid crystal light valves 11R is fixed to block the opening portion 50a, and on the inner side of the first side surface, the phase difference compensating plate 12 is fixed to block the opening portion 50a. That is, the opening portion 50a is blocked in a state where the rim (the circumferential portion) of the opening portion 50a is disposed between the outer rim (outer peripheral portion) of the liquid crystal light valves 11R and the outer rim (outer peripheral portion) of the phase difference compensating plate 12. On the outer side of the second side surface, the exit-side polarization plate 13 is fixed to block the opening portion 50b. On the outer side of the third side surface, the PBS 10 is fixed to block the opening portion 50c. With such a configuration, the inside of the casing 50 is formed to be an airtight space.

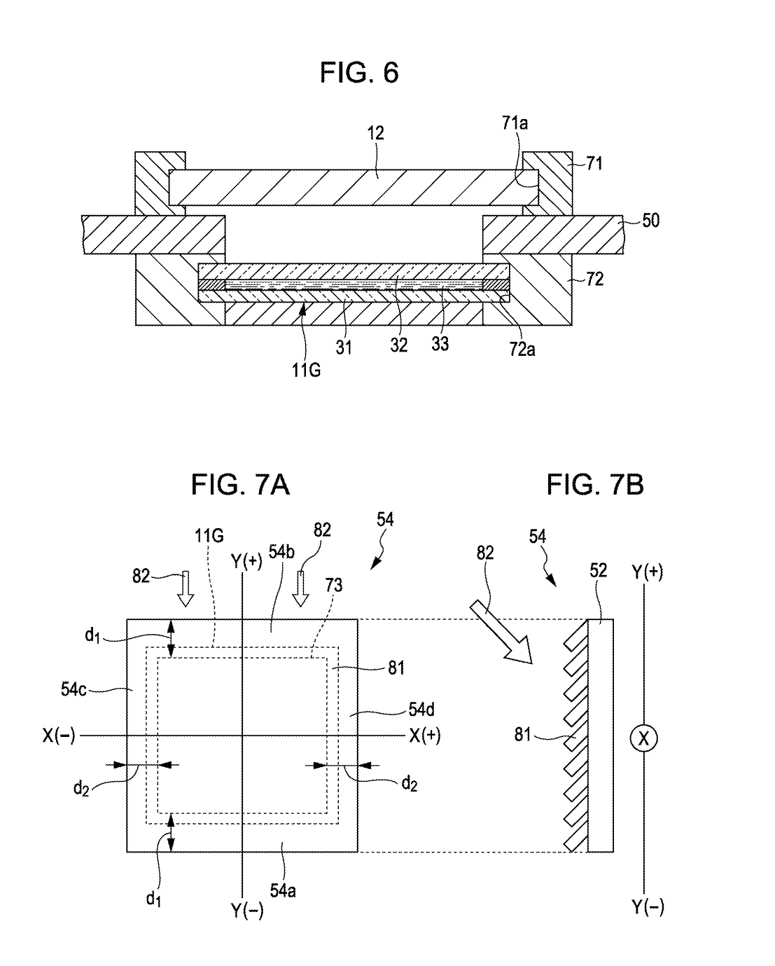

In addition, as shown in FIG. 6, each end portion of the phase difference compensating plate 12 is fixed by being inserted into a groove 71a of a fixture 71 having a rectangular shape or a frame shape. Likewise, each end portion of the liquid crystal light valve 11G for the green light is also fixed by being inserted into a groove 72a of a fixture 72 having a rectangular shape or a frame shape the almost same as the fixture 71. The fixture 71 and the fixture 72 are disposed to block the opening portion 50a, and are mutually fixed by a fixing tool (not shown in the drawing).

Next, the dimensions of the phase difference compensating plate 12 will be described.

As shown in FIGS. 7A and 7B, the O plate 54 of the phase difference compensating plate 12 is formed by obliquely vapor-depositing an inorganic material such as Ta₂O₅ on a surface of the substrate 52 made of quartz glass. Thus, the O plate 54 has a film structure that has columns (tilted column structures) 81 in which inorganic material grows along a tilt direction (in a direction tilted from the substrate surface at a predetermined angle except for 0 and 90 degrees). In addition, the in-plane azimuthal direction (substantially one direction), which is obtained by projecting the tilt direction of the column 81 onto the plane of the substrate, is set as a prescribed homogeneous direction on the entire vapor-deposited surface.

In the O plate 54, the phase difference values disperse in a large direction at end portions 54a and 54b in the tilt direction of the column 81, that is, in the in-plane azimuthal direction (substantially one direction) which is obtained by projecting the vapor deposition direction 82 of the oblique vapor deposition onto the plane of the substrate. In contrast, the phase difference values disperse in a small direction at end portions 54c and 54d in a direction (that is, a direction orthogonal to the in-plane azimuthal direction which is obtained by projecting the vapor deposition direction 82 of the oblique vapor deposition onto the plane of the substrate) orthogonal to the in-plane azimuthal direction (substantially one direction) which is obtained by projecting the tilt direction of the column 81 onto the plane of the substrate. Accordingly, the magnitude (absolute value) of the variation of the phase difference values at the end portions 54a and 54b of the substrate corresponding to the vapor deposition direction 82 is larger than the magnitude (absolute value) of the variation of the phase difference values at the end portions 54c and 54d of the substrate corresponding to the direction orthogonal to the vapor deposition direction 82.

Further, generally, the in-plane azimuthal direction (substantially one direction), which is obtained by projecting the vapor deposition direction 82 onto the plane of the substrate, is a direction, which is parallel with the center line (Y axis of FIGS. 7A and 7B) bisecting one substrate side of the O plate 54, or is within an angular range less than ±45° with respect to the direction. Accordingly, in view of the above, the size of the end portions in the in-plane azimuthal direction, which is obtained by projecting the tilt direction of the column 81 of the O plate 54 onto the plane of the substrate, and on a side which is within an angular range less than ±45° with respect to the center line (Y axis of FIGS. 7A and 7B) bisecting any one of adjacent substrate sides of the O plate 54, that is, the size in the direction from the end portion 54a to the end portion 54b is larger than the size of the end portions in the in-plane azimuthal direction, which is obtained by projecting the tilt direction of the column 81 of the O plate 54, and on a side which is within an angular range larger than ±45° with respect to the center line (X axis of FIGS. 7A and 7B) bisecting another side of the adjacent substrate sides of the O plate 54, that is, the size in the direction from the end portion 54c to the end portion 54d, relative to the display region 73 of the liquid crystal light valves 11G.

As described above, in the O plate 54, the size d₁ of the end portions 54a and 54b out of the display region 73, which is surrounded by a light blocking film serving as a sealing material and a frame of the liquid crystal light valve 11G for the green light, is larger than the size d₂ of the end portions 54c and 54d out of the display region 73.

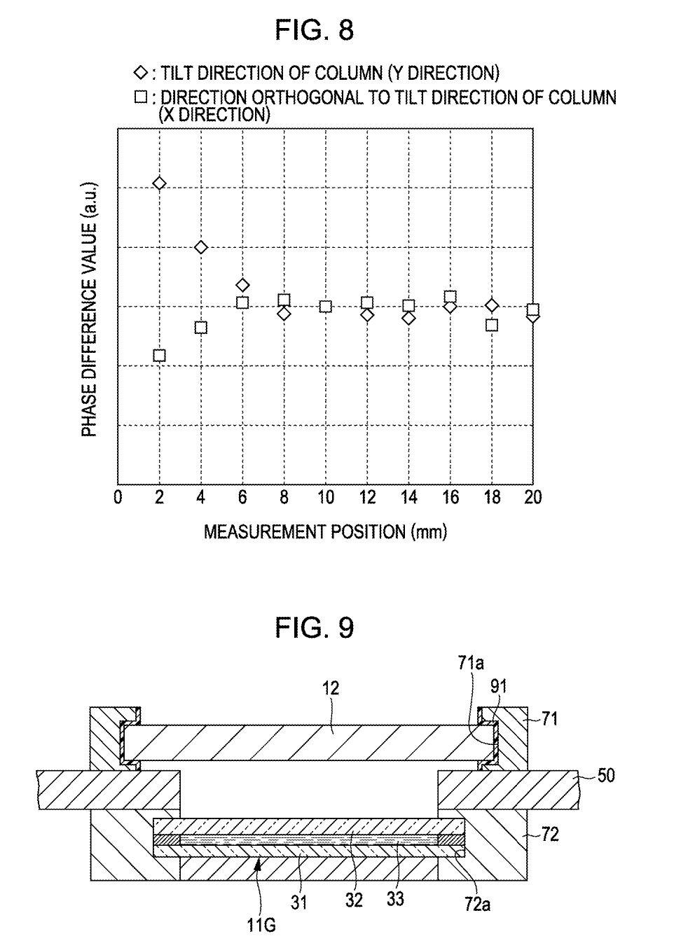

FIG. 8 is a diagram illustrating variation in the phase differences in in-plane directions in the display region of the liquid crystal display apparatus. The in-plane directions are respectively the in-plane azimuthal direction (Y-axis direction), which is obtained by projecting the tilt direction of the column onto the plane of the substrate, and the direction (X-axis direction) which is orthogonal to the in-plane azimuthal direction obtained by projecting the tilt direction of the corresponding column onto the plane of the substrate. In FIG. 8, the distance from the end portion of the display region is set as a measurement position.

According to FIG. 8, the following can be found.

First, the phase difference values disperse in an increase direction at end portions in the in-plane azimuthal direction (Y direction) which is obtained by projecting the tilt direction of the column onto the plane of the substrate. In contrast, the phase difference values disperse in a decrease direction at end portions in the direction (X direction) which is orthogonal to the in-plane azimuthal direction obtained by projecting the tilt direction of the column onto the plane of the substrate.

Second, the magnitude (absolute value) of the variation of the phase difference values in the in-plane azimuthal direction (Y direction), which is obtained by projecting the tilt direction of the column onto the plane of the substrate, is larger than the magnitude (absolute value) of the variation of the phase difference values in the direction (X direction) which is orthogonal to the in-plane azimuthal direction obtained by projecting the tilt direction of the column onto the plane of the substrate.

Third, in the in-plane azimuthal direction (Y direction) which is obtained by projecting the tilt direction of the column onto the plane of the substrate, there is almost no variation of the phase difference values on the positive and negative sides in the Y direction.

From the above, the following was found. In the O plate 54, relative to the display region of the liquid crystal light valves 11G, the size in the in-plane azimuthal direction (Y direction), which is obtained by projecting the tilt direction of the column onto the plane of the substrate, is preferably set to be increased by about 6 mm, and the size in the direction (X-axis direction), which is orthogonal to the in-plane azimuthal direction obtained by projecting the tilt direction of the column onto the plane of the substrate, is preferably set to be increased by about 3 mm.

As described above, according to the projector 1 of the embodiment, the size of the end portion of the O plate 54 of the phase difference compensating plate 12 in the direction on the side, which is within the angular range less than ±45° with respect to the center line bisecting any one of adjacent substrate sides of the O plate 54, is secured to be greater than the size of the end portion of the O plate 54 of the phase difference compensating plate 12 in the direction on the side, which is within the angular range larger than ±45° with respect to the center line bisecting another side of the adjacent substrate sides of the O plate 54, relative to the display region of the liquid crystal light valves 11G. Therefore, the end portions 54a and 54b, which tend to be affected by absorption and desorption of moisture, in the O plate 54 of the phase difference compensating plate 12 can be positioned out of the display region of the liquid crystal light valves 11G. Accordingly, in the display region of the liquid crystal light valves 11G, the display is performed by using only the light which is transmitted through the region of the O plate 54 from which the end portions 54a and 54b are excluded. As a result, it is possible to remove color unevenness and the like caused by the change in phase difference between the center portion and the end portion of the display region of the liquid crystal light valves 11G, and thus it is possible to prevent quality of the display apparatus from deteriorating.

### Second Embodiment

FIG. 9 is a cross-sectional view illustrating a principal section of a triangular prism unit that supports a liquid crystal light valve of a projector according to a second embodiment of the invention. The triangular prism unit of the present embodiment is different from the triangular prism unit of the first embodiment in the following point. In the triangular prism unit of the first embodiment, the end portion of the phase difference compensating plate 12 is fixed by being inserted into the groove 71a of the fixture 71 having a rectangular shape or a frame shape. In contrast, in the triangular prism unit of the embodiment, the end portions of the phase difference compensating plate 12 are covered by a covering material 91, and the end portions of the phase difference compensating plate 12 are inserted into the groove 71a of the fixture 71, which has a rectangular shape or a frame shape, through the covering material 91. Otherwise, the projector according to the embodiment is completely the same as the projector according to the first embodiment.

As the covering material 91, a material capable of preventing moisture from permeating may be used, and examples thereof include covering materials, which have a water-resistant property, such as a thermosetting resin, a thermoplastic resin, an ultraviolet curable resin, an organic-based adhesive, and an inorganic-based adhesive.

The covering material 91 covers the end portion of the phase difference compensating plate 12. Thereby, in the phase difference compensating plate 12, the end portions, which tend to be affected by absorption and desorption of moisture, are covered by the covering material 91. With such a configuration, it is possible to prevent moisture from permeating from the end portions into the phase difference compensating plate 12. Accordingly, there is no concern about occurrence of color unevenness and the like caused by change in phase difference between the center portion and the end portion of the display region of the liquid crystal light valves 11G. In addition, there is no concern about deterioration in quality of the liquid crystal display apparatus.

The projector according to the embodiment is able to provide the same operations and effects as the projector of the first embodiment.

Furthermore, since the end portions of the phase difference compensating plate 12 are covered by the covering material 91, it is possible to prevent moisture from permeating from the end portions into the phase difference compensating plate 12. As a result, it is possible to prevent color unevenness and the like, which are caused by change in phase difference between the center portion and the end portion of the display region of the liquid crystal light valves 11G, from occurring. Consequently, it is possible to prevent quality of the liquid crystal display apparatus from deteriorating.

In addition, the technical scope of the invention is not limited to the embodiments, and various modifications may be added thereto without departing from the scope of the invention. For example, in the embodiment, the size in the tilt direction (Y direction) of the column of the O plate 54 is set to be increased by about 6 mm, and the size in the direction (X-axis direction) orthogonal to the tilt direction of the column is set to be increased by about 3 mm. However, the size may be appropriately set in accordance with the shape or the size of the target liquid crystal light valve.

Otherwise, the material, the shape, the number, the arrangement, and the like of the various components of the projector are not limited to the embodiments, and may be appropriately modified.

The entire disclosure of Japanese Patent Application No. 2011-021879, filed Feb. 3, 2011 is expressly incorporated by reference herein.

What is claimed is:

1. A projection-type display apparatus comprising:
a light source that emits light;
a plurality of vertical-alignment-mode reflective liquid crystal light valves that are provided in corresponding with each of a plurality of different colors, the plurality of vertical alignment mode reflex-type liquid crystal light valves modulate the light of each of the plurality of different colors;
phase difference compensating plates which are respectively provided on the plurality of liquid crystal light valves and in which a plurality of columnar structures made of an inorganic material is inclined toward substantially one direction of in-plane azimuthal directions of each liquid crystal light valve;
a color synthesis optical system that synthesizes the light which are modulated by the plurality of liquid crystal light valves; and
a projection optical system that projects the light, which are synthesized by the color synthesis optical system, onto a projection target surface,
wherein a size of each phase difference compensating plate in the substantially one direction of in-plane azimuthal directions, in which the plurality of columnar structures is inclined, is secured to be larger than a size of a display region of each liquid crystal light valve in a direction corresponding to the substantially one direction.

2. The projection-type display apparatus according to claim 1, wherein end portions of the phase difference compensating plate are covered by a covering material.

3. The projection-type display apparatus according to claim 1, wherein the liquid crystal light valve and the phase difference compensating plate are supported by one surface of each of a plurality of casings of which internal spaces serve as optical paths.

4. The projection-type display apparatus according to claim 1, wherein a size of the end portion of the phase difference compensating plate on a side, in which the substantially one direction of the in-plane azimuthal directions is within an angular range less than ±45° with respect to a line bisecting one substrate side of mutually adjacent sides of the phase difference compensating plate, is secured to be larger than a size of the end portion thereof on a side, in which the substantially one direction of the in-plane azimuthal directions is within an angular range greater than ±45° with respect to a line bisecting the other substrate side of the mutually adjacent sides of the phase difference compensating plate, relative to the display region of each liquid crystal light valve.

5. The projection-type display apparatus according to claim 1, wherein the phase difference compensating plate is formed by combining a C plate with an O plate.
